(19) United States
(12) Patent Application Publication
(10) Pub. No.: US 2018/0075314 A1
(43) Pub. Date: Mar. 15, 2018

(54) READING APPARATUS AND IMAGE READING AND DISPLAYING APPARATUS USING SAME

(71) Applicant: CANON KABUSHIKI KAISHA, Tokyo (JP)

(72) Inventor: Takayuki Sugiyama, Utsunomiya-shi (JP)

(21) Appl. No.: 15/702,029

(22) Filed: Sep. 12, 2017

(30) Foreign Application Priority Data
Sep. 13, 2016 (JP) 2016-178496
Aug. 18, 2017 (JP) 2017-157775

(51) Int. Cl. G06K 9/32; G02B 17/08; G02B 5/10; G06K 9/00; G06K 9/20

(52) U.S. Cl. CPC G06K 9/3275; G02B 17/08; H04N 13/0285; G06K 9/00442; G06K 9/2036; G02B 5/10

(57) ABSTRACT

To provide a reading apparatus capable of obtaining a high-quality image of an object while avoiding complication and increase in size of the whole apparatus, a reading apparatus 1 according to the present invention includes: a placement table including a placement surface 3 on which to place an object; an imaging optical system 12 that condenses a light flux from the object; and an image pickup element 5 that receives the light flux from the imaging optical system 12. At least part of an enlargement-side conjugate plane 6 of the imaging optical system 12 is not parallel to the placement surface 3 and is present on a reduction side with respect to the placement surface.

### BACKGROUND OF THE INVENTION

### Field of the Invention

The present invention relates to a reading apparatus and an image reading and displaying apparatus using the same.

### Description of the Related Art

A reading apparatus has conventionally been known which includes a reflecting optical system, an imaging optical system, and an image pickup element and reads an image of an original placed on a placement surface.

Japanese Patent Application Laid-Open No. 2003-304437 discloses a reading apparatus with optical elements arranged such that a placement surface and the light receiving surface of an image pickup element are conjugate to each other to read a high-quality image of an object.

However, with the reading apparatus disclosed in Japanese Patent Application Laid-Open No. 2003-304437, it is difficult to bring the entire object in focus in a case where the height of the object surface in the optical-axis direction varies at different positions (for example, in a case where the object is an open thick book).

Thus, in a case of pickup an image of an object with such a thickness, there is a problem that the reading resolution greatly varies depending on the position, thereby lowering the image quality.

To solve this problem, one may consider a method in which an imaging optical system is driven with a focusing mechanism to change the focus position of the imaging optical system at each given position on the object.

Employing this method, however, results in complication and increase in size of the whole apparatus.

### SUMMARY OF THE INVENTION

In view of the above, an object of the present invention is to provide a reading apparatus and an image reading and displaying apparatus using the same which are capable of obtaining a high-quality image of an object while avoiding complication and increase in size of the whole apparatus.

A reading apparatus according to the present invention includes: a placement table including a placement surface on which to place an object; an imaging optical system that condenses a light flux from the object; and an image pickup element that receives the light flux from the imaging optical system. At least part of an enlargement-side conjugate plane of the imaging optical system is not parallel to the placement surface and is present on a reduction side with respect to the placement surface.

Further features of the present invention will become apparent from the following description of exemplary embodiments with reference to the attached drawings.

### BRIEF DESCRIPTION OF THE DRAWINGS

FIG. 1 is a schematic perspective view of a reading apparatus according to a first embodiment.

FIG. 2 is a schematic top view of the reading apparatus according to the first embodiment.

FIG. 3 is a schematic cross-sectional view of the reading apparatus according to the first embodiment.

FIG. 4A is a diagram schematically illustrating the dependency of contrast value on defocus position at given reading angles of view in the reading apparatus according to the first embodiment.

FIG. 4B is a diagram schematically illustrating the dependency of contrast value on defocus position at given reading angles of view in the reading apparatus according to the first embodiment.

FIG. 5 is a schematic cross-sectional view of the reading apparatus according to the first embodiment.

FIG. 6 is a cross-sectional view of an optical system of the reading apparatus according to the first embodiment.

FIG. 7 is a cross-sectional view of the reading apparatus according to the first embodiment.

FIG. 8 is a cross-sectional view of an optical system of a reading apparatus according to a second embodiment.

FIG. 9 is a cross-sectional view of the reading apparatus according to the second embodiment.

FIG. 10 is a schematic perspective view of an image reading and displaying apparatus according to the present invention.

FIG. 11 is a cross-sectional view of a conventional reading apparatus.

### DESCRIPTION OF THE EMBODIMENTS

Reading apparatuses according to embodiments will now be described in accordance with drawings. Note that the drawings to be presented below may be depicted on different scales from the actual ones in order to facilitate understanding of these embodiments.

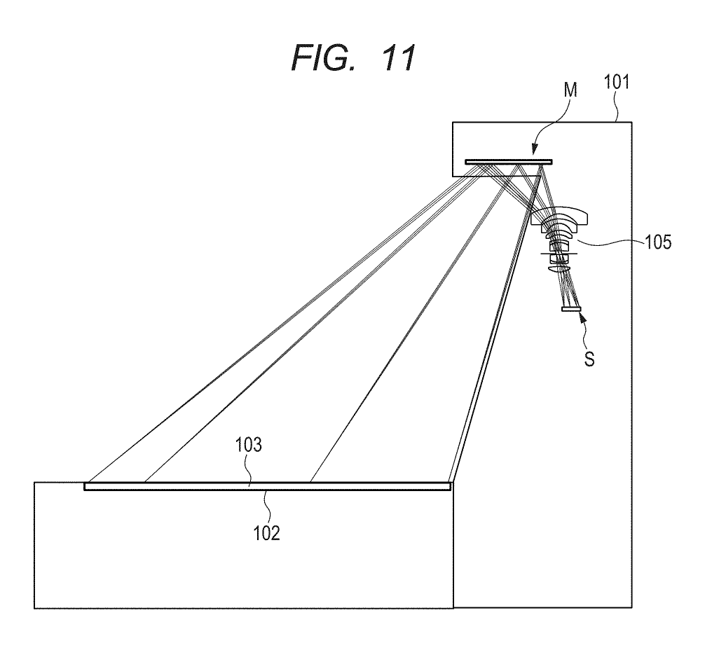

A reading apparatus 101 as illustrated in FIG. 11 has conventionally been known which reads an image of an original 103 placed on a placement surface 102 by using an imaging unit including a reflecting optical system M, an imaging optical system 105, and an image pickup element S.

### First Embodiment

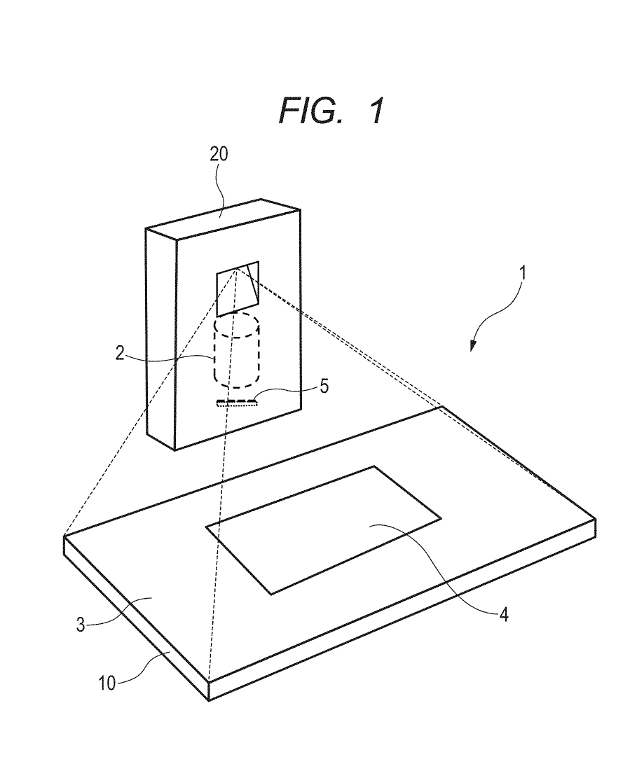

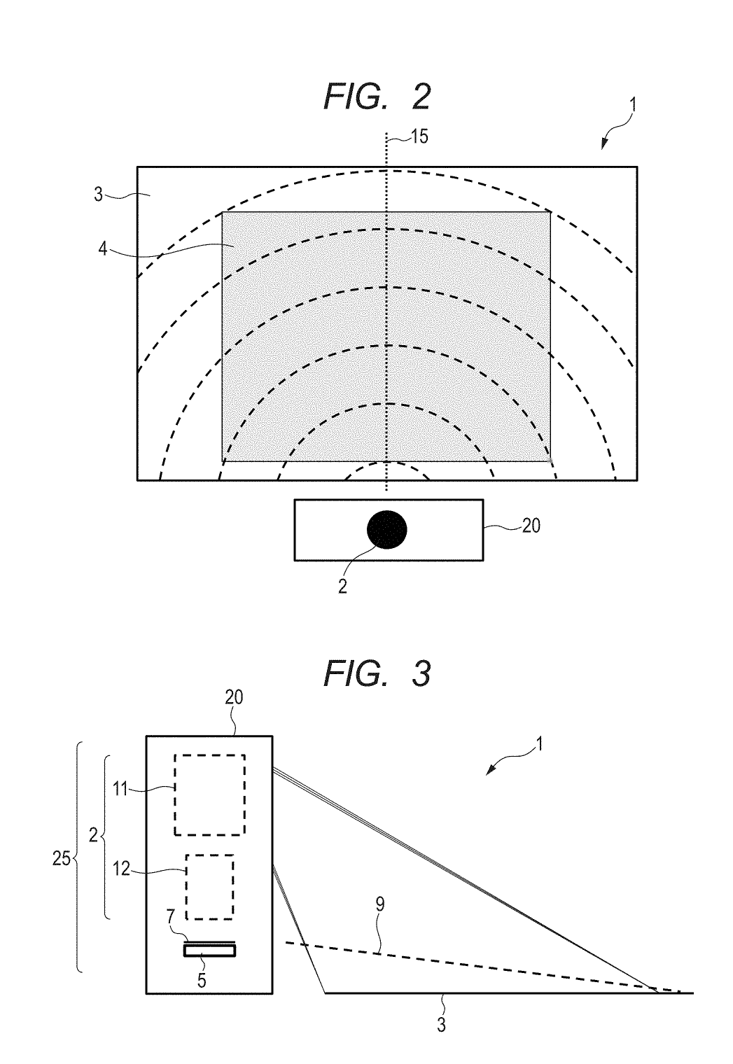

FIG. 1 illustrates a schematic perspective view of a reading apparatus 1 according to a first embodiment. FIG. 2 illustrates a schematic top view of the reading apparatus 1 according to the first embodiment.

The reading apparatus 1 includes a housing 20 in which an optical system 2 and an image pickup element 5 are arranged, and a placement table 10 on which to place an object 4 such as an original.

The optical system 2 includes a reflecting optical system 11 including at least one mirror (reflecting optical element), and an imaging optical system 12 including at least one lens and an aperture stop (see FIG. 3).

In the reading apparatus 1 according to this embodiment, the reflecting optical system 11, the imaging optical system 12, and the image pickup element 5 constitute an imaging unit 25 that pickups an image of the object 4.

The object 4, such as an original, is placed on a placement surface 3 of the placement table 10, and a light flux from the object 4 is reflected by the reflecting optical system 11. The reflected light flux is condensed by the imaging optical system 12 on the light receiving surface of the image pickup element 5.

A charge coupled device (CCD) sensor, a complementary metal oxide semiconductor (CMOS) sensor, or the like can be used as the image pickup element 5.

The reading apparatus 1 is arranged to read an image of the object 4 on the placement surface 3 from obliquely above so that the view of the user of the reading apparatus 1 viewing the object 4 is not obstructed by the housing 20.

In order to reduce the size of the apparatus for such image reading, the optical system 2 of the reading apparatus 1 comprises the reflecting optical system 11, which includes at least one mirror, and the imaging optical system 12, which includes at least one lens and an aperture stop.

In a typical reading apparatus having a structure similar to that of the reading apparatus 1 according to this embodiment, an image of an object on a placement surface is formed on the light receiving surface of an image pickup element through an imaging optical system.

Here, the placement surface and the light receiving surface of the image pickup element are conjugate to each other, and the optical elements of the reading apparatus are arranged such that an enlargement-side conjugate plane and a reduction-side conjugate plane coincide with the placement surface and the light receiving surface of the image pickup element respectively.

However, the reading apparatus 1 according to this embodiment has a reduction-side conjugate plane 7 coincide with the light receiving surface of the image pickup element 5, but does purposely not have an enlargement-side conjugate plane 6 coincide with the placement surface 3.

Specifically, the optical elements of the reading apparatus 1 are arranged such that at least part of the enlargement-side conjugate plane 6 of the imaging optical system 12 is not parallel to the placement surface 3 and is present on the reduction side relative thereto.

More specifically, the optical elements of the reading apparatus 1 are arranged such that the separation amount of at least part of the enlargement-side conjugate plane 6 from the placement surface 3 in the direction of the optical axis of the imaging optical system 12 becomes larger as the reading angle of view of the reading apparatus 1 becomes smaller.

To describe this with FIG. 2, each broken line in FIG. 2 draws the position of the same reading angle of view and is in a parabolic shape. Thus, the closer the broken line is to the housing 20, the smaller the reading angle of view is.

Specifically, in the reading apparatus 1 according to this embodiment, the optical elements are arranged such that at least part of the enlargement-side conjugate plane 6 is separated further from the placement surface 3 toward the reduction side (above the placement surface 3) along the direction of the optical axis of the imaging unit 25 as the reading angle of view of the reading apparatus 1 becomes smaller, that is, such that the amount of the separation is equal along each broken line.

In this way, it is possible to read a high-quality image of the object 4 even in a case where the height of the object 4 in the optical-axis direction varies at different positions of the object 4 such that part of the object 4 is present at higher positions than the placement surface 3 (for example, in a case where the object 4 is an open thick book).

FIG. 3 illustrates a schematic cross-sectional view of the reading apparatus 1 according to this embodiment taken along a first sectional plane 15 including the optical axis of the imaging unit 25 and the center of the placement surface 3.

As illustrated in FIG. 3, at least part of a conjugate line 9 being a line along which the enlargement-side conjugate plane 6 and the first sectional plane 15 cross each other, is above and not parallel to the placement surface 3.

Specifically, at least part of the conjugate line is a straight line inclined relative to the placement surface 3 such that the at least part of the conjugate line 9 is separated further from the placement surface 3 toward the reduction side (above the placement surface 3) along the direction of the optical axis of the imaging unit 25 as the reading angle of view of the reading apparatus 1 becomes smaller.

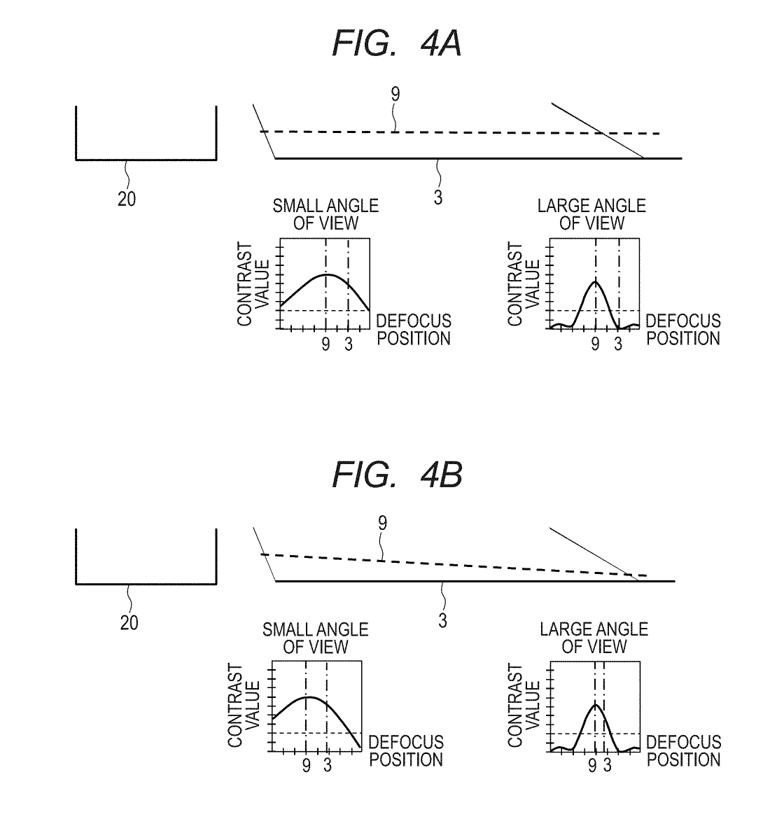

FIGS. 4A and 4B schematically illustrate the dependency of contrast value on defocus position (MTF-Defocus characteristic on the enlargement-side) at given reading angles of view in the reading apparatus 1 according to this embodiment.

Meanwhile, a range of depth that can ensure contrast values greater than and equal to a predetermined value is referred to as the depth-of-field.

As illustrated in FIGS. 4A and 4B, generally, the larger the reading angle of view, the narrower the depth-of-field.

Now, consider that the optical elements of the reading apparatus 1 are arranged such that the enlargement-side conjugate plane 6 is separated from the placement surface 3 toward the reduction side (above the placement surface 3) along the optical-axis direction while remaining parallel to the placement surface 3.

In this case, as illustrated in FIG. 4A, the conjugate line 9 is separated from the placement surface 3 toward the reduction side (above the placement surface 3) along the optical-axis direction while remaining parallel to the placement surface 3.

Then, for each reading angle of view, the contrast value is the greatest value at defocus positions corresponding to the position of the enlargement-side conjugate plane 6 (conjugate line 9).

Thus, it is possible to read a high-quality image of the object 4 even in the case where the height of the object 4 in the optical-axis direction varies at different positions of the object 4 such that part of the object 4 is present at higher positions than the placement surface 3 (for example, in the case where the object is an open thick book).

However, it can be seen that at defocus positions corresponding to the position of the placement surface 3, the contrast value does not significantly decrease at small reading angles of view but the contrast value drastically decreases at large reading angles of view.

Thus, with such a design, in a case of reading an image of a thin original 4 placed on the placement surface 3, an image having good contrast values can be read with respect to regions of the original 4 corresponding to small reading angles of view; however, an image having good contrast values cannot be read with respect to regions corresponding to large reading angles of view.

In view of the above, in the reading apparatus 1 according to this embodiment, the optical elements of the reading apparatus 1 are arranged such that at least part of the enlargement-side conjugate plane 6 is separated further from the placement surface 3 toward the reduction side (above the placement surface 3) along the optical-axis direction as the reading angle of view of the reading apparatus 1 becomes smaller.

In this case, as illustrated in FIG. 4B, at least part of the conjugate line 9 is a straight line inclined relative to the placement surface 3 such that the at least part of the conjugate line 9 is separated further from the placement surface 3 toward the reduction side (above the placement surface 3) along the optical-axis direction as the reading angle of view of the reading apparatus 1 becomes smaller.

In this way, at large reading angles of view, the contrast value does not significantly decrease even at defocus positions corresponding to the position of the placement surface 3. Hence, it is possible to ensure sufficient contrast values over the entire placement surface 3 and thereby read a high-resolution image even from a thin original 4.

It is also possible to read a high-quality image of an object 4 even in the case where the height of the object 4 in the optical-axis direction varies at different positions of the object 4 such that part of the object 4 is present at higher positions than the placement surface 3 (for example, in the case where the object is an open thick book).

In other words, the reading apparatus 1 according to this embodiment is designed such that the enlargement-side conjugate plane 6 does not coincide with the placement surface 3 but is non-uniformly separated therefrom in the optical-axis direction, by utilizing the fact that the depth-of-field is sufficiently large at small reading angles of view.

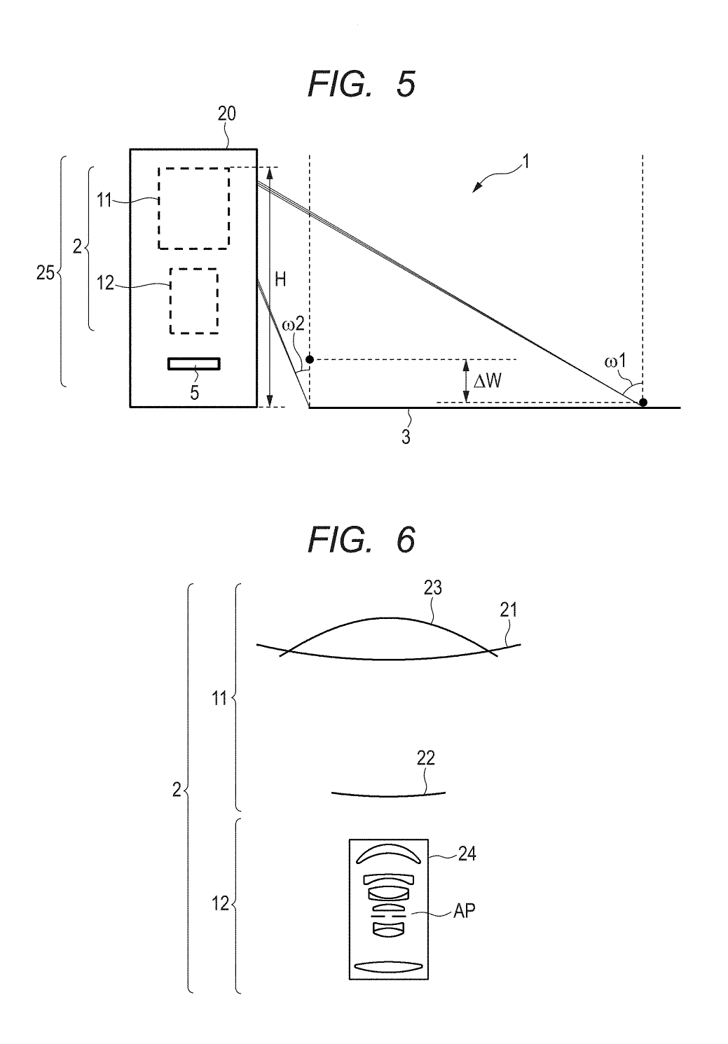

Here, the reading apparatus 1 according to this embodiment satisfies the following conditional expression (1), where ω₁ and ω₂ are the largest reading angle of view and the smallest reading angle of view respectively, H is the distance along the optical axis of the imaging optical system 12 from the placement surface 3 to the reflecting optical element closest to the enlargement-side among the reflecting optical elements of the reflecting optical system 11, and ΔW is the distance in the direction of the optical axis of the imaging optical system 12 between the center of the depth of field at the largest reading angle of view ω₁ and the center of the depth of field at the smallest reading angle of view ω₂ on the enlargement-side (see FIG. 5).

0<|ΔW/(H×(tan ω₁−tan ω₂))|≦0.2 (1)

The reading apparatus 1 according to this embodiment can read a high-quality image of the object 4 by arranging the optical elements of the reading apparatus 1 to separate the enlargement-side conjugate plane 6 from the placement surface 3 in such a way as to satisfy the conditional expression (1).

If the upper limit value of the conditional expression (1) is exceeded, sufficient contrast values cannot be obtained over the entire reading region, thus making it difficult to read a high-quality image of the object 4.

FIG. 6 illustrates a cross-sectional view of the optical system 2 of the reading apparatus 1 according to this embodiment.

As illustrated in FIG. 6, the reflecting optical system 11 of the reading apparatus 1 according to this embodiment includes a first mirror 21 having a negative power, a second mirror 22 having a positive power, and a third mirror 23 having a positive power in this order along the optical path from the enlargement-side.

Moreover, the imaging optical system 12 includes a lens group 24 comprising multiple coaxial lenses and having a positive power as a whole, and an aperture stop AP that determines the f-number of the imaging optical system 12.

Meanwhile, the reflecting surface of the third mirror (first reflecting optical element) 23 is formed in the shape of an aspherical surface that is rotationally symmetric about the optical axis of the imaging unit 25.

This is because the reading apparatus 1 according to this embodiment reads an image of the object 4 on the placement surface 3 from obliquely above and therefore optically corrects distortion occurring in the read image.

Next, the numerical values of the optical system 2 of the reading apparatus 1 according to this embodiment are presented in table 1 below.

TABLE 1

| Surface | | | | |
|---|---|---|---|---|
| number i | Rᵢ | Dᵢ | N_{d i} | ν_{d i} |
| 1 | −417.24 | 96.9 | | |
| 2 | −303.96 | −126.6 | | |
| 3* | 100.05 | 160.5 | | |
| 4 | 27.47 | 6.2 | 1.605 | 43.7 |
| 5 | 34.14 | 15 | | |
| 6 | 134.77 | 2.8 | 1.806 | 40.92 |
| 7 | 29.19 | 5.7 | | |
| 8 | 51.46 | 8.5 | 1.603 | 65.44 |
| 9 | −25.17 | 1.6 | 1.697 | 55.53 |
| 10 | −72.19 | 2.7 | | |
| 11 | 28.99 | 4.4 | 1.648 | 53.02 |
| 12 | −3895.3 | 4 | | |
| 13AP | 0 | 5.9 | | |
| 14 | −39.56 | 2.5 | 1.883 | 40.8 |
| 15 | 27.76 | 6.1 | 1.488 | 70.23 |
| 16 | −22.7 | 17.8 | | |
| 17 | 132.02 | 7.5 | 1.606 | 43.7 |
| 18 | −82.35 | 37.1 | | |

| Surface | | | | | |
|---|---|---|---|---|---|
| number | K | C4 | C6 | C8 | C10 |
| 3 | −0.9814 | 6.15E−08 | 4.16E−12 | 8.94E−17 | −2.43E−20 |

| | |
|---|---|
| fd | 19.85 |
| Fno | 11 |
| β | 0.044 |
| ω₁ | 58° |
| ω₂ | 28° |

Meanwhile, in table 1, surface number i represents the order of an optical surface from the enlargement-side along the optical path of the optical system 2, Rᵢ represents the curvature radius of the i-th surface, Dᵢ represents the interval between the i-th surface and the i+l-th surface, and N_{di} represents the refractive index between the i-th surface and the i+l-th surface for the d-line. Also, ν_{di} represents a value expressed by the following expression (2), where N_{Fi} is the refractive index between the i-th surface and the i+l-th surface for the F-line, and N_{ci} is the refractive index between the i-th surface and the i+1-th surface for the C-line.

ν_{di}=(N_{di}−1)/(N_{Fi}−N_{Ci}) (2)

The optical surface with an asterisk attached to its surface number represents an aspherical surface, and the surface presented as AP is the aperture stop AP.

Also, the aspherical surface shape is expressed by the following expression (3) with A(r) as the surface position in the optical-axis direction at a distance r, where K is the eccentricity, Ci (i=1, 2, 3, . . . ) is the aspherical coefficient, and r is the distance from the optical axis of the imaging unit 25 in a direction perpendicular to the optical axis.

$$A ( r ) = \frac{{r}^{2} / R}{1 + \sqrt{1 - ( 1 + K ) {r}^{2} / {R}^{2}}} + {C}_{1} {r}^{1} + {C}_{2} {r}^{2} + {C}_{3} {r}^{3} + {C}_{4} {r}^{4} + {C}_{5} {r}^{5} + … . \qquad ( 3 )$$

Here, R is the paraxial curvature radius, and “E-N” in each aspherical coefficient means “×10^{-N}.”

Also, fd represents the focal length of the imaging optical system 12, Fno represents the f-number of the imaging optical system 12 on the reduction side, and β represents the image magnification of the imaging optical system 12.

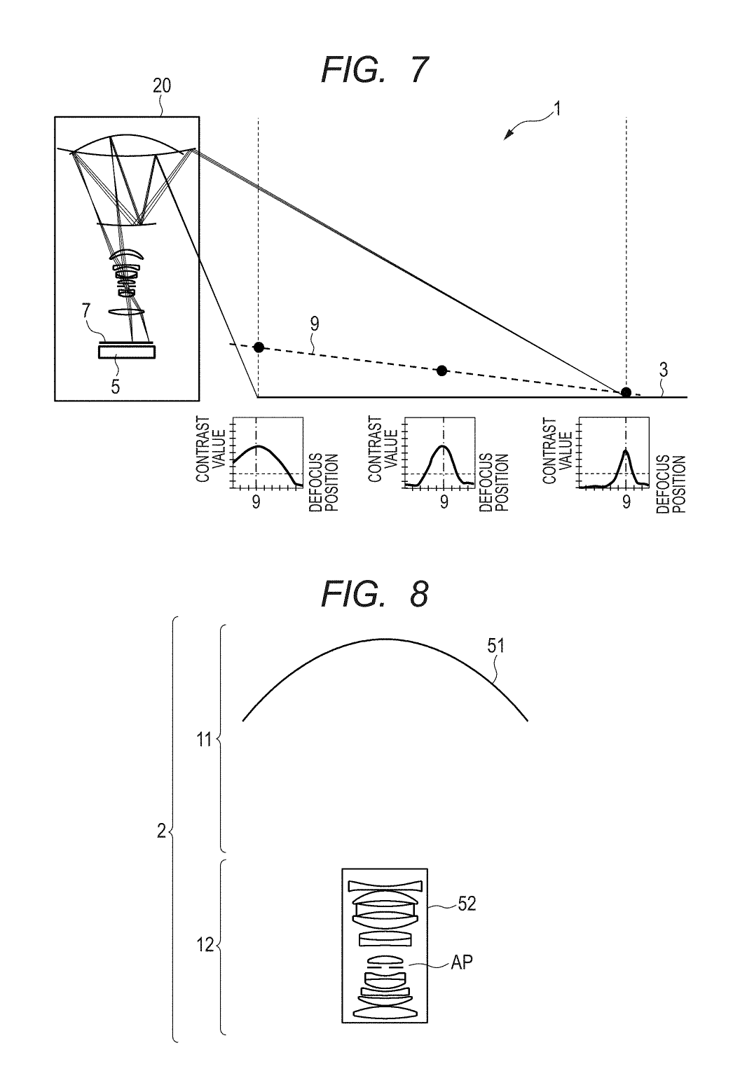

FIG. 7 illustrates a cross-sectional view of the reading apparatus 1 according to this embodiment taken along the first sectional plane 15, including the optical axis of the imaging unit 25 and the center of the placement surface 3.

In the reading apparatus 1 according to this embodiment, the design and arrangement of the optical elements are devised such that at least part of the enlargement-side conjugate plane 6 is separated further from the placement surface 3 toward the reduction side (above the placement surface 3) along the optical-axis direction as the reading angle of view becomes smaller.

Specifically, as illustrated in FIG. 7, at least part of the conjugate line 9 is a straight line inclined relative to the placement surface 3 such that the at least part of the conjugate line 9 is separated further from the placement surface 3 toward the reduction side (above the placement surface 3) along the optical-axis direction as the reading angle of view of the reading apparatus 1 becomes smaller.

In the reading apparatus 1 according to this embodiment, the largest reading angle of view ω₁ and the smallest reading angle of view ω₂ are 58° and 28° respectively, and the distance H along the optical axis of the imaging optical system 12 from the placement surface 3 to the first mirror 21, which is the reflecting optical element of the reflecting optical system 11 closest to the enlargement-side, is 352 mm.

Also, the center of a depth range (depth-of-field) corresponding to 20% of the largest contrast value in the MTF-Defocus profile is set as the center of the depth of field. In this case, the distance ΔW in the direction of the optical axis of the imaging optical system 12 between the center of the depth of field at the largest reading angle of view ω₁ and the center of the depth of field at the smallest reading angle of view ω₂ on the enlargement-side is 50 mm.

Thus, in the reading apparatus 1 according to this embodiment, |ΔW/(H×(tan ω₁−tan ω₂))|=0.13, which shows that conditional expression (1) is satisfied.

From the above, the reading apparatus 1 according to this embodiment can read a high-quality image of the object 4 regardless of whether the object 4 is, for example, an open thick book, which has a varying height in the optical-axis direction at different positions of the object 4, or a thin and flat original.

### Second Embodiment

A reading apparatus 26 according to a second embodiment includes the same components as those of the reading apparatus 1 according to the first embodiment. Thus, the same components are represented by the same reference numerals, and description thereof will be omitted.

In the reading apparatus 26 according to this embodiment, unlike the reading apparatus 1 according to the first embodiment, the image pickup element 5 is inclined such that field curvature caused by the optical system 2 is suppressed and the light receiving surface of the image pickup element 5, which coincides with the reduction-side conjugate plane 7, is not perpendicular to the optical axis of the imaging unit 25. In this way, at least part of the enlargement-side conjugate plane 6 is separated from the placement surface 3 toward the reduction side (above the placement surface 3) along the optical-axis direction.

FIG. 8 illustrates a cross-sectional view of the optical system 2 of the reading apparatus 26 according to this embodiment.

As illustrated in FIG. 8, the reflecting optical system 11 of the reading apparatus 26 according to this embodiment includes a first mirror 51 having a positive power.

Moreover, the imaging optical system 12 includes a lens group 52 comprising multiple coaxial lenses and having a positive power as a whole, and an aperture stop AP that determines the f-number of the imaging optical system 12.

Meanwhile, the reflecting surface of the first mirror (first reflecting optical element) 51 is formed in the shape of an aspherical surface that is rotationally asymmetric about the optical axis of the imaging unit 25.

This is because the reading apparatus 26 according to this embodiment reads an image of the object 4 on the placement surface 3 from obliquely above and therefore optically corrects distortion occurring in the read image.

Also, unlike the reading apparatus 1 according to the first embodiment, the first mirror 51 is formed to be rotationally asymmetric to enhance the degree of freedom in its aspherical shape in order to further enhance the optical performance. In this way, various aberrations can be well corrected even when the reading angle of view is ultra-wide.

Next, the numerical values of the optical system 2 of the reading apparatus 26 according to this embodiment are presented in table 2 below.

TABLE 2

| Surface | | | | |
|---|---|---|---|---|
| number i | Rᵢ | Dᵢ | N_{di} | ν_{di} |
| 1* | 88.17 | 174.2 | | |
| 2* | −70.97 | 2.5 | 1.583 | 59.38 |
| 3* | 0.00 | 0.7 | | |
| 4 | 36.38 | 7.2 | 1.654 | 39.70 |
| 5 | 106.05 | 3.9 | | |
| 6 | −101.38 | 3.8 | 1.762 | 40.10 |
| 7 | 68.64 | 4.9 | | |
| 8 | −108.74 | 7.0 | 1.729 | 54.68 |
| 9 | −47.81 | 1.9 | | |
| 10 | 85.46 | 6.2 | 1.595 | 67.74 |
| 11 | −116.08 | 3.7 | 1.702 | 41.24 |
| 12 | 541.84 | 7.5 | | |
| 13 | 28.07 | 5.3 | 1.595 | 67.74 |
| 14 | −131.71 | 2.7 | | |
| 15 AP | 0 | 6.0 | | |
| 16 | −25.88 | 2.3 | 1.883 | 40.76 |
| 17 | 221.73 | 6.7 | 1.595 | 67.74 |
| 18 | −28.23 | 2.0 | | |
| 19 | −49.15 | 2.9 | 1.816 | 46.62 |
| 20 | −527.60 | 2.0 | | |
| 21* | −220.78 | 5.2 | 1.583 | 59.38 |
| 22 | −39.74 | 0.7 | | |
| 23 | 63.10 | 8.5 | 1.497 | 81.54 |
| 24 | −118.74 | 36.0 | | |

| Surface | | | | | | | |
|---|---|---|---|---|---|---|---|
| number i | K | C1 | C4 | C6 | C8 | C10 | C12 |
| 1 | −9.28E−01 | 1.21E−03 | −6.47E−08 | 9.17E−12 | −4.54E−16 | 1.40E−20 | 0.00E+00 |
| 2 | −1.78E+00 | 0.00E+00 | 9.40E−07 | −2.36E−09 | 8.53E−12 | −2.77E−15 | −1.10E−18 |
| 3 | 0.00E+00 | 0.00E+00 | −4.40E−08 | −6.38E−10 | 8.29E−12 | −7.90E−16 | 0.00E+00 |
| 21 | −3.87E+01 | 0.00E+00 | −2.92E−06 | −1.58E−08 | 3.63E−11 | −8.77E−14 | 0.00E+00 |

| | |
|---|---|
| fd | 13.6 |
| Fno | 1 |
| β | 0.044 |
| ω₁ | 68° |
| ω₂ | 28° |

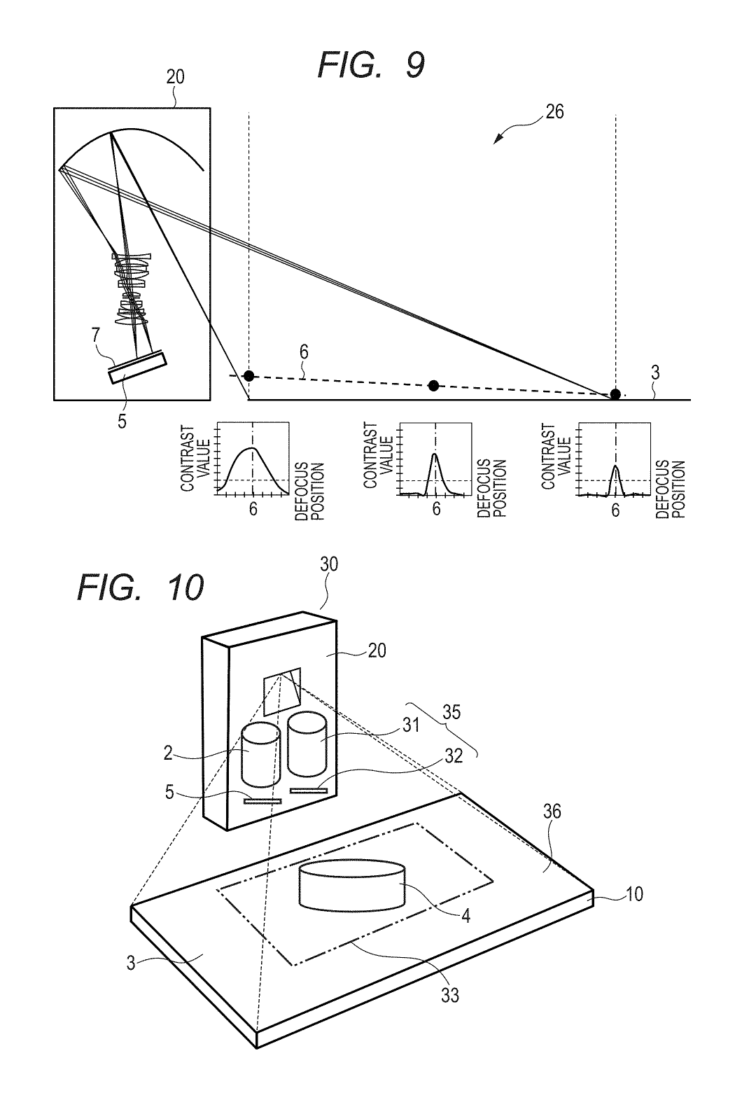

FIG. 9 illustrates a cross-sectional view of the reading apparatus 26 according to this embodiment taken along the first sectional plane 15, including the optical axis of the imaging unit 25 and the center of the placement surface 3.

As illustrated in FIG. 9, in the reading apparatus 26 according to this embodiment, the image pickup element 5 is inclined such that the light receiving surface of the image pickup element 5, which coincides with the reduction-side conjugate plane 7, is not perpendicular to the optical axis of the imaging unit 25. In this way, the separation amount of at least part of the enlargement-side conjugate plane 6 from the placement surface 3 in the direction of the optical axis of the imaging optical system 12 becomes larger as the at least part of the enlargement-side conjugate plane 6 gets closer to the imaging optical system 12 along a line along which the first sectional plane 15, including the optical axis of the imaging optical system 12 and the center of the placement surface 3, and the enlargement-side conjugate plane 6 cross each other. Moreover, the at least part of the enlargement-side conjugate plane 6 is a plane forming an angle with the placement surface 3.

In the reading apparatus 26 according to this embodiment, the largest reading angle of view ω₁ and the smallest reading angle of view φ₂ are 68° and 28° respectively, and the distance H along the optical axis of the imaging optical system 12 from the placement surface 3 to the first mirror 51, which is the reflecting optical element of the reflecting optical system 11 closest to the enlargement-side, is 380 mm.

Also, the center of a depth range (depth-of-field) corresponding to 20% of the largest contrast value in the MTF-Defocus profile is set as the center of the depth of field. In this case, the distance ΔW in the direction of the optical axis of the imaging optical system 12 between the center of the depth of field at the largest reading angle of view ω₁ and the center of the depth of field at the smallest reading angle of view ω₂ on the enlargement-side is 20 mm.

Thus, in the reading apparatus 26 according to this embodiment, |ΔW/(H×(tan ω₁−tan ω₂))|=0.03, which shows that conditional expression (1) is satisfied.

From the above, the reading apparatus 26 according to this embodiment can read a high-quality image of the object 4 regardless of whether the object 4 is, for example, an open thick book, which has a varying height in the optical-axis direction at different positions of the object 4, or a thin and flat original.

Note that although preferred embodiments have been described above, the present invention is not limited to these embodiments, but various modifications and variations are possible within a range not departing from the gist.

For example, in the reading apparatus 1 according to the first embodiment, the optical elements are arranged such that at least part of the enlargement-side conjugate plane 6 is separated further from the placement surface 3 toward the reduction side (above the placement surface 3) along the direction of the optical axis of the imaging unit 25 as the reading angle of view becomes smaller. In addition to this, the image pickup element 5 may be inclined as in the second embodiment, or subjected to an electric process, to make the light receiving surface of the image pickup element 5 not perpendicular to the optical axis of the imaging unit 25 such that at least part of the enlargement-side conjugate plane 6 is separated further from the placement surface 3 toward the reduction side (above the placement surface 3) along the direction of the optical axis of the imaging unit 25 as the at least part of the enlargement-side conjugate plane 6 gets closer to the imaging unit 25 along the line along which the enlargement-side conjugate plane 6 and the first sectional plane 15 cross each other.

Also, the reading apparatuses according to the first and second embodiments use the reflecting optical system 11, the imaging optical system 12, and the image pickup element 5 to read an image of the object 4. However, the present invention is not limited to this. The above configuration is applicable to reading apparatuses that use only an imaging optical system and an image pickup element to read an image of an object. In this case, the imaging optical system and the image pickup element constitute an imaging unit that pickups an image of an object.

[Image Reading and Displaying Apparatus]

FIG. 10 illustrates a schematic perspective view of an image reading and displaying apparatus 30 according to this embodiment.

The image reading and displaying apparatus 30 according to the present invention includes a housing 20 in which an imaging optical system 2, an image pickup element 5, a displaying element 32 that displays an image, and a projecting optical system 31 that forms an image of the image (condenses a light flux from the displaying element 32) are arranged, and a placement table 10 on which to place an object 4.

The imaging optical system 2 is the same as the optical system 2 mounted in the above-described reading apparatus according to the first or second embodiment. In other words, the imaging optical system 2 includes a reflecting optical system and an imaging optical system.

In the image reading and displaying apparatus 30 according to the present invention, the imaging optical system 2 and the image pickup element 5 constitute an imaging unit 25 that pickups an image of the object 4.

Moreover, the projecting optical system 31 and the displaying element 32 constitute a projecting unit 35 that projects an image onto a projection surface 36.

Meanwhile, although the placement surface 3 and the projection surface 36 are the same surface in the image reading and displaying apparatus 30 according to this embodiment, they may be different surfaces.

In the image reading and displaying apparatus 30 according to this embodiment, the user can select a reading mode according to the type of object 4.

For example, the user can select a “flat-original imaging mode” when the object 4 is in a flat shape such as an original, and select a “three-dimensional-object imaging mode” when the object 4 is a three-dimensional object with a height.

In the image reading and displaying apparatus 30, the image unit 25 used in the reading apparatus according to the first embodiment or the second embodiment is employed. Hence, at least part of the enlargement-side conjugate plane is not parallel to the placement surface 3 and is present on the reduction side relative thereto.

Also, as mentioned above, a sufficient depth-of-field can be ensured when reading angle of view is small.

Thus, the image reading and displaying apparatus 30 according to this embodiment displays an object placement region 33 on the placement surface 3 on a side where the reading angle of view is small when the “three-dimensional-object imaging mode” is selected. Following this display, the user places an object 4 at the position with a sufficient depth-of-field. In this way, it is possible to read a higher-quality image of the object 4.

Meanwhile, a storing unit not illustrated of the image reading and displaying apparatus 30 according to this embodiment may store the relation between the reading angle of view and the depth-of-field. Then, after having the user input information on the height of the object 4, a calculating unit not illustrated may calculate a necessary and sufficient object placement region 33, and the projecting unit 35 may display the calculated object placement region 33 on the placement surface 3.

According to the present invention, a reading apparatus and an image reading and displaying apparatus using the same can be provided which are capable of acquiring a high-quality image of an object while avoiding complication and increase in size of the whole apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-178496, filed Sep. 13, 2016, and Japanese Patent Application No. 2017-157775, filed Aug. 18, 2017, which are hereby incorporated by reference herein in their entirety.

What is claimed is:

1. A reading apparatus comprising:
a placement table including a placement surface on which to place an object;
an imaging optical system that condenses a light flux from the object; and
an image pickup element that receives the light flux from the imaging optical system,
wherein at least part of an enlargement-side conjugate plane of the imaging optical system is not parallel to the placement surface and is present on a reduction side with respect to the placement surface.

2. The reading apparatus according to claim 1, wherein a separation amount of the at least part of the enlargement-side conjugate plane from the placement surface in a direction of an optical axis of the imaging optical system becomes larger as a reading angle of view of the reading apparatus becomes smaller.

3. The reading apparatus according to claim 1, wherein a separation amount of the at least part of the enlargement-side conjugate plane from the placement surface in a direction of an optical axis of the imaging optical system becomes larger as the at least part of the enlargement-side conjugate plane gets closer to the imaging optical system along a line along which the enlargement-side conjugate plane and a first sectional plane cross each other, the first sectional plane including the optical axis of the imaging optical system and a center of the placement surface.

4. The reading apparatus according to claim 3, wherein the at least part of the enlargement-side conjugate plane is a plane forming an angle with the placement surface.

5. The reading apparatus according to claim 3, wherein a light receiving surface of the image pickup element is not perpendicular to the optical axis of the imaging optical system.

6. The reading apparatus according to claim 1, further comprising at least one reflecting optical element that reflect a light flux from the object toward the imaging optical system,
wherein a first reflecting optical element among the at least one reflecting optical element includes an aspherical reflecting surface.

7. The reading apparatus according to claim 6, wherein 0<|ΔW/(H×(tan ω₁−tan ω₂))|≦0.2 is satisfied, where ω₁ and ω₂ are a largest reading angle of view and a smallest reading angle of view respectively, H is a distance along an optical axis of the imaging optical system from the placement surface to a reflecting optical element closest to an enlargement-side among the at least one reflecting optical element, and ΔW is a distance in a direction of the optical axis between a center of a depth of field at the largest reading angle of view ω₁ and a center of a depth of field at the smallest reading angle of view ω₂.

8. The reading apparatus according to claim 6, wherein the reflecting surface is an aspherical surface that is rotationally symmetric about an optical axis of the imaging optical system.

9. The reading apparatus according to claim 6, wherein the reflecting surface is an aspherical surface that is rotationally asymmetric about an optical axis of the imaging optical system.

10. An image reading and displaying apparatus comprising:
a placement table including a placement surface on which to place an object;
an imaging optical system that condenses a light flux from the object;
an image pickup element that receives the light flux from the imaging optical system; and
a projecting unit that projects an image,
wherein at least part of an enlargement-side conjugate plane of the imaging optical system is not parallel to the placement surface and is present on a reduction side with respect to the placement surface, and
the projecting unit projects a placement region on which to place the object on the placement surface when a three-dimensional-object imaging mode is selected.

11. The image reading and displaying apparatus according to claim 10, wherein the placement region is calculated from information on a height of the object.
